(19) United States
(12) Patent Application Publication
(10) Pub. No.: US 2010/0014124 A1
(43) Pub. Date: Jan. 21, 2010

(54) PORTABLE BUSINESS CARD SCANNER

(76) Inventor: Kevin Deal, Vestaburg, MI (US)

Correspondence Address: Kevin Deal, 10998 N. Crystal Road, Vestaburg, MI, 48891, US

(21) Appl. No.: 12/176,495

(22) Filed: Jul. 21, 2008

(51) Int. Cl. H04N 1/024

(52) U.S. Cl. 358/473

(57) ABSTRACT

Disclosed is a portable business card scanner for scanning, storing and displaying an encoded image of a business card. The portable business card scanner includes a casing, a scanner, at least one memory, at least one input device and a display device. The scanner is configured to scan the business card to generate an encoded image thereof. The at least one memory is configured to store the encoded image of the business card. The at least one input device is configured to retrieve the encoded image from the at least one memory and add a labeling data to the encoded image. The display device is configured to display the encoded image of the business card.

### FIELD OF THE INVENTION

The present invention relates generally to document scanning devices, and, more particularly, to a portable business card scanner adapted to scan a business card, and to store and display an encoded image thereof.

### BACKGROUND OF THE INVENTION

Exchanging business cards is a common practice at commercial and social events. The business cards may be exchanged for a variety of reasons, such as for introduction, providing relevant information, promoting business contacts, promoting communications and the like. A business card may include information regarding a person, such as the name of the person, the type of business the person undertakes, the designation of the person, contact details and the like. Generally, the business card is stored in various storage containers such as a case, a file, a folder and the like. These storage containers are large and bulky and, accordingly, are cumbersome to carry and use. Moreover, retrieval of business cards from such storage containers is difficult and time consuming.

For facilitating easy storage of information of a business card various types of electronic devices such as a Personal Digital Assistant (PDA), a portable computer, and the like are used. These electronic devices permit a user to store the information provided on the business card as textual information, such as by the name of a person, through various input devices such as a keyboard and the like. However, such electronic devices have various limitations. For example, the textual information of the business card needs to be manually transcribed into such devices through the various input devices. The manual transcription of the text data into such electronic devices is cumbersome and time consuming. Moreover, graphic information, such as a logo and a graphic trademark, of the business card may not be transferred during the manual transcription.

Accordingly, based on the foregoing, there is a need for a portable device which is capable of storing and displaying both textual information and a graphic information of a business card in an easy and reliable manner. More specifically, there is a need for a portable device which reduces the amount of effort required to enter textual information and graphic information of a business card into the portable device and retrieve such information therefrom.

### SUMMARY OF THE INVENTION

In view of the foregoing disadvantages inherent in the prior art, the general purpose of the present invention is to provide a portable business card scanner that is configured to include all the advantages of the prior art, and to overcome the drawbacks inherent therein.

Accordingly, an object of the present invention is to provide a portable business card scanner that is capable of storing and displaying both textual information and graphic information of a business card.

Another object of the present invention is to provide a portable business card scanner that reduces the amount of effort required to enter textual information and graphic information of a business card and retrieve such information therefrom.

In light of the above objects, a portable business card scanner adapted to scan a business card to generate an encoded image thereof, and store and display the encoded image is disclosed. The portable business card scanner includes a casing, a scanner, at least one memory, at least one input device and a display device. The scanner is disposed in the casing. Further, the scanner is configured to scan a business card to generate an encoded image thereof. The at least one memory is disposed in the casing and is communicably coupled to the scanner. The at least one memory is configured to store the encoded image of the business card. Furthermore, the at least one input device is configured on the casing and is communicably coupled to the scanner. The at least one input device is configured to retrieve the encoded image of the business card from the at least one memory and add a labeling data to the encoded image of the business card. Moreover, the display device is configured on the casing and is communicably coupled to the scanner. The display device is configured to display the encoded image of the business card.

In another aspect of the present invention, the portable business card scanner further includes at least one Universal Serial Bus (USB) port configured on a peripheral edge portion of the casing and communicably coupled to the scanner.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, in which:

FIG. 1 illustrates a perspective view of a portable business card scanner, in accordance with an embodiment of the present invention; and

FIG. 2 illustrates a block diagram of the portable business card scanner of FIG. 1, in accordance with an embodiment of the present invention.

Like reference numerals refer to like parts throughout the description of several views of the drawings.

### DETAILED DESCRIPTION OF THE INVENTION

The exemplary embodiments described herein detail for illustrative purposes are subject to many variations in structure and design. It should be emphasized, however, that the present invention is not limited to a particular portable business card scanner as shown and described. It is understood that various omissions and substitutions of equivalents are contemplated as circumstances may suggest or render expedient, but these are intended to cover the application or implementation without departing from the spirit or scope of the claims of the present invention.

The terms “a” and “an” herein do not denote a limitation of quantity, but rather denote the presence of at least one of the referenced item.

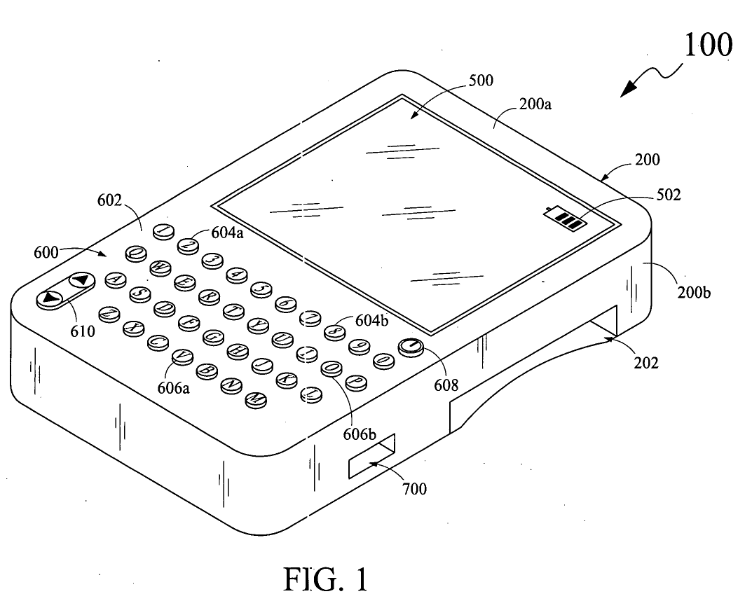

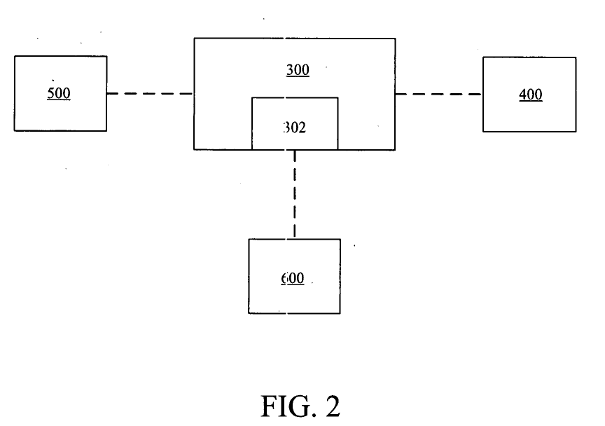

Referring to FIG. 1 and FIG. 2, a portable business card scanner 100 adapted to scan a business card, and store and display an encoded image thereof, is illustrated. More specifically, FIG. 1 illustrates a perspective view of the portable business card scanner 100 (hereinafter referred to as “portable scanner 100”) in accordance with an embodiment of the present invention and FIG. 2 illustrates a block diagram of the portable scanner 100. The portable scanner 100 includes a casing 200, a scanner 300, at least one memory 400, a display device 500 and at least one input device 600.

The casing 200 is configured to accommodate the scanner 300 and the at least one memory 400 therewithin. Further, the display device 500 and the at least one input device 600 are configured on the casing. More specifically, as shown in FIG. 1, the display device 500 and the at least one input device 600 are configured on a top face 200a of the casing 200. The casing 200 may configure various three-dimensional shapes such as a cube, a cuboid and the like. The casing 200 is configured to have a size that enables a user to easily carry the portable scanner 100 in his/her pocket, a glove box of his/her vehicle or any other suitable place. In one embodiment of the present invention, the casing 200 may be about four and a half inches in length, about four inches in width and about one inch in height. Further, the casing 200 may be composed of various materials such as a plastic material, a light weight metal and the like. In one embodiment of the present invention, the casing 200 further includes a slot 202 configured on a peripheral edge portion, such as a peripheral edge portion 200b, of the casing 200. The slot 202 is adapted to receive a business card (not shown).

The scanner 300 (shown in FIG. 2) is disposed in the casing 200. The scanner 300 is configured to receive the business card and scan textual and graphic information of the business card to generate an encoded image thereof. More specifically, the business card received in the slot 202 may be directed to the scanner 300 for scanning thereof. The scanner 300 may be configurationally and operationally similar to conventional scanners utilized for scanning documents except for the fact that the scanner 300 is configured in a small size for being incorporated in the portable scanner 100. In one embodiment of the present invention, the scanner 300 includes various elements such as a motor (not shown), an image sensor (not shown), a card input roller (not shown) and the like for enabling scanning of the business card. The card input roller is rotated by the motor for driving the business card over the image sensor for enabling scanning thereof. The image sensor is configured to generate the encoded image of the business card. The image sensor may include a charge-coupled device (CCD), a contact image sensor (CIS), a magnetic sensor, a photomultiplier tube and the like. In one embodiment of the present invention, the scanner 300 may further include a processor 302 (shown in FIG. 2) for controlling operation of the scanner 300 by enabling the various elements of the scanner 300 to interact with each other. The processor 302 may be selected from various processors known in the art.

Further, the various elements of the scanner 300 may be enclosed in a housing (not shown) to configure the scanner 300 as a compact unit. The housing may have an opening (not shown) configured to receive the business card for carrying out scanning thereof. In one embodiment of the present invention, the scanner 300 may be disposed in the slot 202 in a manner such that an opening of the slot 202 is adjacent to the opening in the housing of the scanner 300. Such an arrangement directs the business card received in the slot 202 to the scanner 300 through the opening of the scanner 300 for enabling scanning of the business card. In another embodiment of the present invention, the scanner 300 may further include a scanner plate (not shown) which may extend out of the slot 202 for receiving the business card therein.

Further, the at least one memory 400 (shown in FIG. 2) is communicably coupled to the scanner 300. In one embodiment of the present invention, the at least one memory 400 is communicably coupled to the processor 302 of the scanner 300. The at least one memory 400 is configured to store the encoded image of the business card generated by the scanner 300. In one embodiment of the present invention, the at least one memory 400 may include a volatile memory, such as a random access memory (RAM), and a non-volatile memory, such as a read only memory (ROM), a flash memory and the like. In one embodiment of the present invention, the at least one memory 400 is configured to store encoded images of about 250 business cards. In another embodiment of the present invention, the at least one memory 400 is configured to store images of about 500 business cards. In yet another embodiment of the present invention, the at least one memory 400 is configured to store images of about 750 business cards.

The encoded image of the business card may be retrieved from the at least one memory 400 and displayed on the display device 500. Further, the display device 500 is communicably coupled to the scanner 300 for enabling the display of the encoded image of the business card thereon. In one embodiment of the present invention, the display device 500 may be communicably coupled to the processor 302 of the scanner 300. The display device 500 is adapted to display at least one of an encoded image of a business card generated by the scanner 300 and an encoded image of a business card retrieved from the at least one memory 400. Further, in one embodiment of the present invention, the display device 500 is adapted to display a single encoded image of a business card or a list of encoded images of a plurality of business cards. Still further, in one embodiment of the present invention, the display device 500 is configured to display the encoded image of the business card in an alphabetical order. Furthermore, in one embodiment of the present invention, the display device 500 is configured to display a symbol 502 representing amount of charging present in a rechargeable battery providing power to the portable device 100. Moreover, the display device 500 may include a liquid crystal display (LCD) device, a touchscreen, and the like. Furthermore, the display device 500 is responsive to the at least one input device 600.

As shown in FIG. 2, the at least one input device 600 is communicably coupled to the scanner 300. In one embodiment of the present invention, the at least one input device 600 may be communicably coupled to the processor 302 of the scanner 300. The at least one input device 600 is configured to retrieve the encoded image of the business card stored in the at least one memory 400 for displaying on the display device 500. The at least one input device 600 is further configured to add labeling data to the encoded image of the business card. In one embodiment of the present invention, adding labeling data to the encoded image of the business card includes inserting name of a person, type of business of the person, a personalized comment, a nickname for the person, a card index number and the like to the encoded image. The addition of the labeling data enables easy retrieval and identification of the business card. The at least one input device 600 may be further configured to annotate the encoded image of the business card.

In one embodiment of the present invention, the at least one input device 600 includes a keyboard 602. The keyboard 602 includes a plurality of numeral keys, such as a numeral key 604a and a numeral key 604b. The plurality of numeral keys is hereinafter collectively referred to as “numeral keys 604”. The keyboard 602 further includes a plurality of alphabetical keys, such as an alphabetical key 606a and an alphabetical key 606b. The plurality of alphabetical keys is hereinafter collectively referred to as “alphabetical keys 606”. The numeral keys 604 and the alphabetical keys 606 are configured to annotate and add the labeling data to the encoded image of the business card. The numeral keys 604 and the alphabetical keys 606 may be further configured to retrieve an encoded image of a business card from the at least one memory 400. For example, the numeral keys 604 may retrieve an encoded image of a business card from the at least one memory 400 by entering a card index number of the business card.

The at least one input device 600 may further include an on/off key 608 configured to start and/or stop operation of the portable scanner 100. In one embodiment of the present invention, the at least one input device 600 may include a scroll button 610. The scroll button 610 is configured to enable a user to scroll up and down through a list of encoded images of business cards being displayed on the display screen 500. In one embodiment of the present invention, the touchscreen may act as the at least one input device 600.

In use, a user may insert a business card in the slot 202 of the casing 200. The slot 202 directs the business card to the opening of the scanner 300. The scanner 300 scans textual and graphic information of the business card to generate an encoded image thereof. The encoded image of the business card is stored in the at least one memory 400. The encoded image of the business card is displayed on the display device 500. Further, the encoded image of the business card may be incorporated with a labeling data by utilizing the at least one input device 600. Furthermore, the user may retrieve the stored encoded image of the business card from the at least one memory 400 by utilizing the at least one input device 600. For example, the encoded image may be retrieved by using a first letter of name of a person, a card index number and the like.

Further, in one embodiment of the present invention, the portable scanner 100 further includes at least one Universal Serial Bus (USB) port 700 configured on a peripheral edge portion, such as the peripheral edge portion 200b, of the casing 200. The USB port 700 is communicably coupled to the scanner 300. In one embodiment of the present invention, the USB port 700 may be communicably coupled to the processor 302. The USB port 700 is configured to connect the portable scanner 100 to a computer for enabling a user to access the encoded images of business cards stored in the portable scanner 100. The USB port 700 may be further adapted to connect the portable scanner 100 to various peripheral devices such as a printer, for enabling the user to take print-outs of the encoded images of the business cards.

The portable scanner 100 may be powered by a power source known in the art such as a DC power source, an AC power source, a battery and the like. In one embodiment of the present invention, the portable scanner 100 includes at least one rechargeable battery (not shown) for enabling portability of the portable scanner 100. The at least one rechargeable battery may be disposed in the casing 200. The rechargeable battery may be operated by the on/off key 608 such that a power supply from the rechargeable battery may be started or stopped upon selective operation of the on/off key 608.

In one embodiment of the present invention, the portable scanner 100 may include a software that facilitates the portable scanner 100 to additionally function as a calculator. In another embodiment of the present invention, the portable scanner 100 further includes an independent processor disposed in the casing 200 and communicably coupled to the scanner 300, the at least one memory 400, the display device 500 and the at least one input device 600. The independent processor is configured to control various operations of the portable scanner 100. In yet another embodiment of the present invention, the casing 200 may include a logo (not shown) on a surface of the casing 200.

Various embodiments of the present invention offer following advantages. The portable business card scanner, as described herein, may be advantageously used by a user for storing and displaying both textual and graphic information of business cards, thereby avoiding a need for the user to carry the business cards with him/her for reference. Further, the portable business card scanner reduces the amount of effort required to enter and retrieve the textual and the graphic information of the business cards. Moreover, the portable business card scanner of the present invention is capable of reducing expenses required for frequent printing of the business cards. More specifically, a person having the portable business card scanner may readily scan and return the business card provided to him/her by other people, thereby avoiding the people to carry a plurality of business cards. Additionally, the portable business card scanner is capable of annotating scanned encoded image of a business card, thereby enabling a user to customize the business card.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present invention.

What is claimed is:

1. A portable business card scanner, the portable business card scanner comprising:
a casing;
a scanner disposed in the casing, the scanner configured to scan a business card to generate an encoded image thereof;
at least one memory disposed in the casing and communicably coupled to the scanner, the at least one memory configured to store the encoded image of the business card;
at least one input device configured on the casing and communicably coupled to the scanner, the at least one input device configured to retrieve the encoded image from the at least one memory and add a labeling data to the encoded image; and
a display device configured on the casing and communicably coupled to the scanner, the display device configured to display the encoded image of the business card.

2. The portable business card scanner of claim 1, wherein the casing further comprises a slot configured on a peripheral edge portion of the casing, the slot adapted to receive the business card to generate the encoded image thereof by the scanner.

3. The portable business card scanner of claim 1 further comprising at least one rechargeable battery for providing power to the portable business card scanner.

4. The portable business card scanner of claim 1, wherein the display device is a liquid crystal display (LCD) device.

5. The portable business card scanner of claim 1, wherein the display device is a touchscreen.

6. The portable business card scanner of claim 1, wherein the at least one input device comprises a keyboard.

7. The portable business card scanner of claim 1, wherein the at least one input device comprises a scroll button.

8. The portable business card scanner of claim 1 further comprising at least one Universal Serial Bus (USB) port communicably coupled to the scanner, the USB port configured on a peripheral edge portion of the casing.
